(19) United States
(12) Patent Application Publication
(10) Pub. No.: US 2007/0201727 A1
(43) Pub. Date: Aug. 30, 2007

(54) User identification for fitness equipment

(75) Inventors: James S. Birrell, Seattle, WA (US); David E. Dyer, Renton, WA (US); Victor Pipinich, Seattle, WA (US)

Correspondence Address: Precor Incorporated;(c/o) Wilson Sporting Goods Co.), 8700 W. Bryn Mawr Avenue, Chicago, IL, 60631, US

(73) Assignee: Precor Incorporated

(21) Appl. No.: 11/352,701

(22) Filed: Feb. 13, 2006

(51) Int. Cl. G06K 9/00

(52) U.S. Cl. 382/115; 340/5.53

(57) ABSTRACT

In accordance with the principles of the present invention, an user identification system for a fitness trainer is provided. An operating system architecture for the fitness trainer includes a hardware circuit board, a processor in communication with the hardware circuit board, and memory in communication with the hardware circuit board and the processor. A biometric capture mechanism in communication with the processor and the memory.

### FIELD OF THE INVENTION

The present invention relates to fitness equipment operating systems.

### BACKGROUND OF THE INVENTION

From their humble beginnings as free weights and bicycles mounted on wooden platforms, exercise equipment such as stationary bicycles, treadmills, elliptical fitness trainers, rowing machines, stair climbers, weight resistance machines, and the like have grown increasingly sophisticated. Not only has the mechanical aspects of these machines improved, with innovations such as adjustable platforms, variable resistance, and a wide range of exercising positions, but the microprocessing capabilities of these exercise devices has improved markedly. Thus, today's exercise equipment offers users a wide variety of different exercise patterns; not only patterns design to burn a specified number of calories or cover a specified distance, but also complex workout patterns such as interval workouts, course patterns, etc.

As the sophistication of the exercise equipment has increased, so also the sophistication of exercise science has improved. Today's sophisticated health club user typically cross-trains by using a plurality of exercise equipment rather than focusing on a single type of modality. In addition, today's sophisticated health club user will alter the volume or intensity of their exercise routines in a pattern referred to as periodization. Often today's exercise users are following an exercise program scientifically designed for maximum benefit over a period of time. The user's workout information is tracked over time by the user or a fitness facility where the user exercises, with adjustments made to the program based on feedback from the results of exercise routines. As a result, the user, the fitness trainer, and/or the health club are faced with the daunting task of gathering and organizing data across a wide range of products over long periods of time.

Some current exercise devices that attempt to track a user's workout data require a user to input a user identification code into the exercise device microprocessor, a time consuming act that is subject to user error and requires the health clubs to issue and track the identification codes. Other exercise devices that attempt to track a user's workout data require the user to carry a card, which can be easily lost or stolen and an inconvenience to the user who typically is dressed in light exercise clothing. Thus, it would be desirable to provide improved user identification in exercise equipment.

### SUMMARY OF THE INVENTION

The present invention provides an operating system architecture for a fitness trainer. The operating system includes a display, a processor in communication with the display, a hardware circuit board in communication with the processor, memory in communication with the hardware circuit board and the processor, and a biometric capture mechanism in communication with the processor and the memory. The memory is capable of storing template biometric data with which biometric data captured by the biometric capture mechanism is compared.

According to a principal aspect of the invention, a fitness device includes a frame, first and second foot links, first and second foot supporting portions for receiving the feet of the user, a coupling, a guide, a display, a processor, memory and a biometric capture mechanism. The frame has a pivot axis defined thereon, and is configured to be supported on a floor. The first and second foot links each include a first portion and a second portion. The first and second foot support portions supported by the first and second foot links, respectively. The coupling is associated with the first portion of each foot link for coupling the first portion of each foot link to the pivot axis so that the first portion of each foot link travels in a closed path relative to the pivot axis. The guide is associated with the frame and operative to engage and direct the second portions of the foot links along preselected reciprocating paths of travel as the first portions of the respective foot links travel along their paths of travel, so that when the exercise device is in use the foot support portion moves along a generally elliptical path of travel. The display is in communication with the foot link, the processor is in communication with the display, the memory is in communication with the processor, and the biometric capture mechanism is in communication with the processor and the memory.

According to another principal aspect of the present invention, a system of identifying a user for a fitness trainer includes the steps of capturing a user biometric, extracting data from the biometric and storing the data as a template, and capturing a sample of the chosen biometric. The system further includes the steps of the user of the fitness equipment presenting a live biometric, and utilizing a matching algorithm to compare the live biometric with the stored templates, whereby, if a match is made, the user is granted access to operate the fitness trainer.

In another aspect in accordance with the principles of the present invention, the biometric capture mechanism is a hand biometric system. In another aspect in accordance with the principles of the present invention, the biometric capture mechanism is a face biometric system.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates an elevated front perspective view of a fitness device in accordance with the principles of the present invention.

FIG. 2 illustrates an elevated, side view of the fitness device of FIG. 1.

FIG. 3 shows a view screen and electronic housing incorporating a fingerprint biometric identification system in accordance with the principles of the present invention.

FIG. 4 shows a schematic of an example architecture of a biometric identification system in accordance with the principles of the present invention.

FIG. 5 an electric circuit diagram of an example capacitive fingerprint scanner in accordance with the principles of the present invention.

FIG. 6 shows a view screen and electronic housing incorporating a hand geometry biometric identification system in accordance with the principles of the present invention.

FIG. 7 is a schematic showing the hand measurements of a hand geometry biometric identification system of the present invention.

FIG. 8 shows a view screen and electronic housing incorporating a face identification biometric system in accordance with the principles of the present invention is seen.

FIG. 9 is a flow-chart of an example biometric identification system in accordance with the principles of the present invention.

### DETAILED DESCRIPTION OF THE INVENTION

While an exemplary embodiment of the invention has been illustrated and described, it will be appreciated that various changes can be made therein without departing from the spirit and scope of the invention.

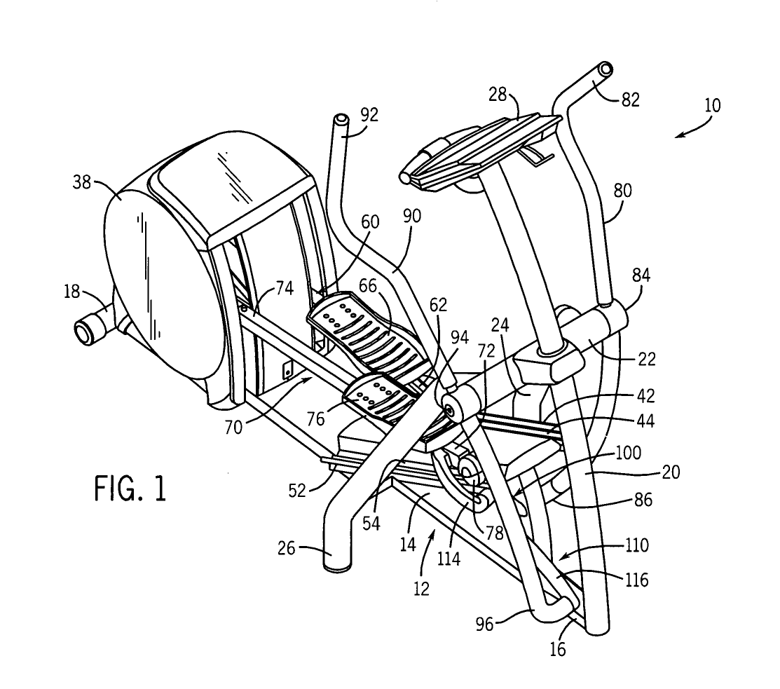

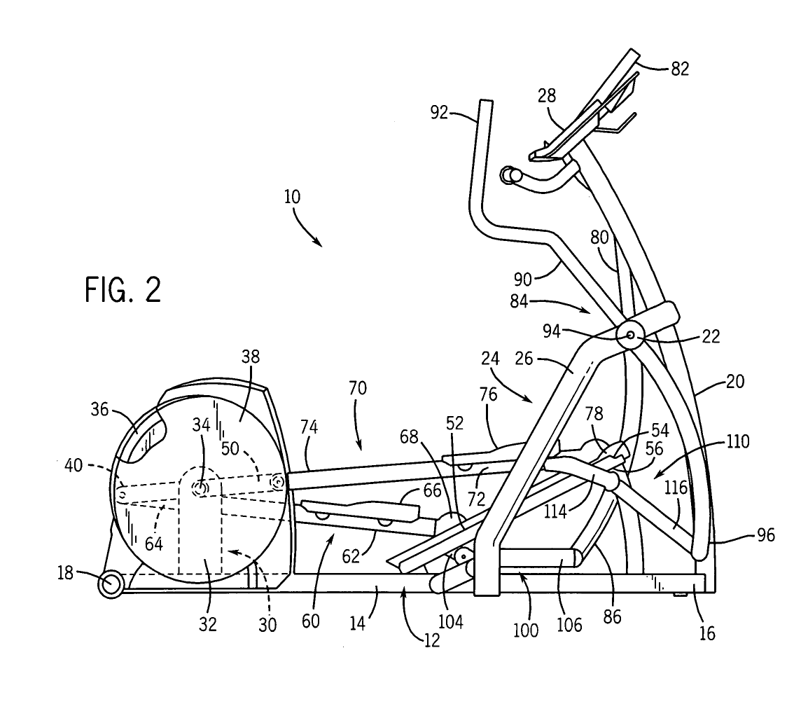

FIGS. 1-2 illustrate an example embodiment of a fitness device in the form of a total body elliptical fitness cross-training device 10 suitable for use with the present invention. While the example embodiment described herein is a Precor® Elliptical Fitness Cross-trainer (available from Precor Incorporated, Woodinville, Wash. 98072 USA), the principles of the present invention apply to any other fitness devices, including but not limited to treadmills, stair climbers, stationary bikes, rowing machines, stair climbers, weight resistance machines and the like.

Briefly described, the fitness device 10 includes a frame 12 that has a forward upright member 20, a forward end portion 16 and a rearward end portion 18. Preferably, the forward end portion 16 of the frame 12 can simply terminate at the end of a substantially horizontal, longitudinal central member 14, while the rearward end portion 18 can terminate at a relatively shorter transverse member. Ideally, but not essentially, the frame 12 can be composed of tubular members that can be relatively light in weight but that provide substantial strength and rigidity. The frame 12 also may be composed of solid members that provide the requisite strength and rigidity while maintaining a relatively lightweight.

The forward upright member 20 extends upwardly from the longitudinal central member 14 of the frame 12. Preferably, the upright member 20 can be slightly rearward curved; however, the forward member 20 may be configured at other upward angles. A relatively short, transversely oriented crossbar member 22 can be connected to the forward upright member 20. Left and right balance arms 24, 26 can depend downwardly from each end of the crossbar member 22 to engage the floor on each side of the longitudinal central member 14 near the forward end of the fitness device 10, thereby increasing stability. Ideally, but not essentially, these members can be composed of a material similar to that described above, and can be formed in quasi-circular tubular configurations.

Left and right axle mounts 30, 32 (seen in FIG. 2) extend upwardly towards the rear region of the frame 12. The axle mounts 30, 32 support a transverse axle 34 that can be preferably operatively connected to a flywheel 36 contained within a center housing 38. The regions of the axle mounts 30, 32 which house the ends of the transverse axle 34, can contain low friction engaging systems, such as bearing systems (not shown), to allow the transverse axle 34 to rotate with little resistance within the housing in the axle mounts 30, 32. The transverse axle 34 also may be operatively connected to a capstan-type drive (not shown) in some embodiments, to allow the axle 34 to rotate in one direction.

The left and right ends of the transverse axle 34 rotatably engage left and right crank arm assemblies 40, 50. Left and right foot links 60, 70 each include a forward end 62, 72, a rearward end 64, 74, and a foot support portion 66, 76 there between. The foot support portions 66, 76 are positioned near the forward portion of the foot links 60, 70, and provide stable foot placement locations. The foot links 60, 70 are aligned in approximately parallel relationship with the longitudinal central member 14 of the frame 12. The rearward ends 64, 74 of the foot links 60, 70 engage the crank arm assemblies 40, 50 such that the foot support portion 66, 76 of the foot links travel in a generally arcuate or elliptical reciprocal path as the transverse axle 34 rotates. In some exemplary embodiments, the foot support portions 66, 76 can be configured to form toe straps and/or toe and heel cups (not shown) which aid in forward motion recovery at the end of a rearward or forward striding motion of a foot.

The forward ends 62, 72 of the foot links 60, 70 preferably are supported by rollers 68, 78, which engage guide tracks 42, 52 (best seen in FIG. 1) that are mounted to the frame 12. Preferably, the engagement rollers 68, 78 can be actually pairs of rollers. The engagement rollers 68, 78 rotate about axles that are affixed to the forward portions 62, 72 of the foot links 60, 70. In one embodiment, the guide tracks can be statically mounted to the frame 12. The guide tracks 42, 52 can be completely separate members or can be part of one single connected unit. The guide tracks 42, 52 attach to the longitudinal central member 14 of the frame 12 at an angled inclination. In one embodiment, the angle of inclination can be approximately thirty degrees (30°). In an alternative embodiment, the guide tracks can incorporate a mechanism such as a motor (not shown) and a lead screw (not shown) for selectively adjusting the inclination of the guide tracks.

Preferably, the upper surface of the guide tracks 42, 52 can be shaped to contain two longitudinally extending, adjacent engagement grooves 44, 54 (seen in FIG. 1). These engagement grooves 44, 54 give the upper surface of the guide tracks 42, 52 a generally “W-shaped” cross-sectional configuration. The engagement grooves 44, 54 are specifically sized and shaped to correspondingly mate with the rollers 68, 78 of the foot links 60, 70 in order to assist in the lateral containment of the rollers 68, 78 on the guide tracks. During use of the fitness device 10, the engagement rollers 68, 78 at the front of the foot links 60, 70 translate back and forth the length of the guide tracks 42, 52 in rolling engagement within the grooves 44, 54, as the foot support portions 66, 76 of the foot links 60, 70 travel in an arcuate path of motion, and the rearward portions 64, 74 of the foot links 60, 70 rotate about the transverse axle 34.

The forward ends 62, 72 of the foot links 60, 70 can be operatively connected to engagement assemblies 100, 110, which in turn can be operatively connected to the coupling regions 86, 96 of left and right swing arm mechanisms 80, 90, respectively. Each swing arm mechanism 80, 90 contains a hand-gripping portion 82, 92, a pivot point 84, 94, and a coupling region 86, 96. The pivot points 84, 94 rotatably secure the swing arm mechanisms 80, 90 to each end of the crossbar member 22 of the frame 12. The coupling regions 86, 96 of the swing arm mechanisms 80, 90 rotatably connect to the engagement assemblies 100, 110, and turn to the foot support portions 66, 76 of the foot links 60, 70. Each engagement assembly 100, 110 includes an abutment arm 106, 116 and a curved attachment link 104, 114, which together prevent the derailment of the foot link rollers 68, 78 from the guide tracks 42, 52.

The hand-gripping portions 82, 92 of the swing arm mechanisms 80, 90 are grasped by the hands of the user, and allow upper body arm and shoulder exercising motions to be incorporated in conjunction with the reciprocal, elliptical exercising motion traced out by the feet of the user. The linking of the swing arm mechanisms 80, 90 to the foot links 60, 70, via the engagement assemblies 100, 110, and the rotational securement of the swing arm mechanisms 80, 90 to the forward upright member 20 of the frame 12 at the pivot points 84, 94, results in generally rearward, arcuate motion of a hand-gripping portion being correspondingly linked to a generally forward, arcuate motion of a respective foot support portion, and vice versa.

To use this fitness device 10, the user stands on the foot support portions 66, 76 and grasps the hand-gripping portions 82, 92. The user imparts a rearward stepping motion on one of the foot support portions and a forward stepping motion on the other foot support portion, thereby causing the transverse axle 34 to rotate in a clockwise direction (when viewed from the right side as shown in FIGS. 1 and 2), due to the crank arm assemblies 40, 50 coupling the motion of the foot links 60, 70 to the rotation of the transverse axle 34. In conjunction with the lower body action, the user also imparts a substantially forward pushing motion on one of the hand-gripping portions and a substantially rearward pulling motion on the other hand-gripping portion. Due to the rotatable connection of the coupling regions 86, 96 of the swing arm mechanisms 80, 90 to the forward portions 62, 72 of the foot links 60, 70 (via the engagement assemblies), and the rotational securement of the swing arm mechanisms 80, 90 to the forward upright member 20 of the frame 12 at their pivot points 84, 94, each hand-gripping portion moves forward as its respective foot support portion moves rearward, and vice versa.

The foot links 60, 70 are attached to the transverse axle 34 by the crank arm assemblies 40, 50 such that one foot support portion moves substantially forward as the other foot support portion moves substantially rearward. In this same fashion, one hand-gripping portion moves forward as the other hand-gripping portion moves rearward (e.g., when the left hand-gripping portion 82 moves forward, the left foot support portion 66 moves rearward, while the right foot support portion 76 moves forward and the right hand-gripping portion 92 moves rearward). Therefore, the user can begin movement of the entire foot link and swing arm mechanism linkage by moving any foot support portion or hand-gripping portion, or preferably by moving all of them together.

Again, while the example embodiment depicts a total body elliptical fitness cross-training device, the principles of the present invention apply to any other fitness devices, including but not limited to treadmills, stair climbers, stationary bikes, rowing machines, stair climbers, weight resistance machines and the like.

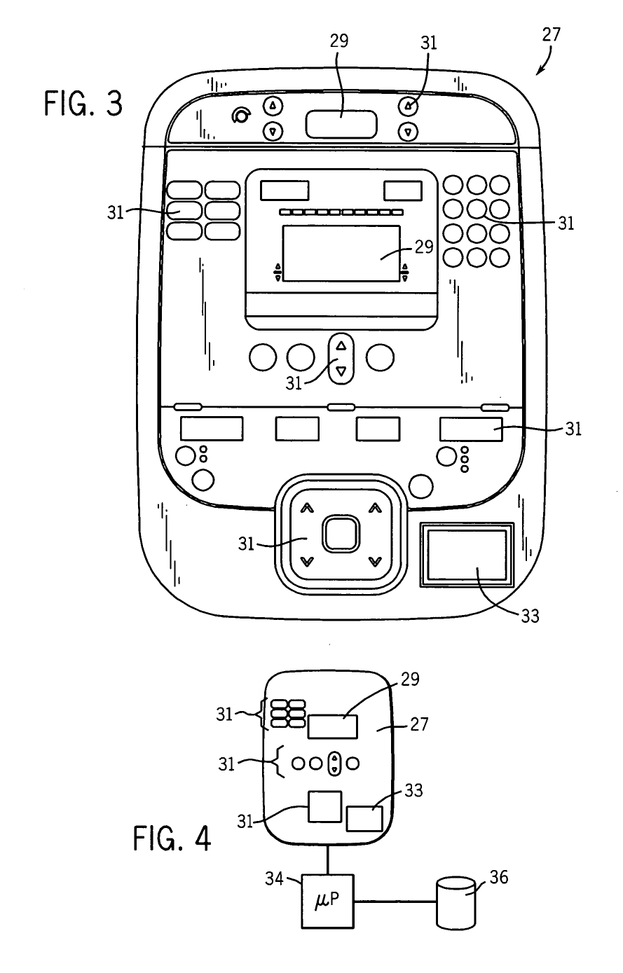

Preferably, a view screen 27 contained in electronic housing 28 is securely connected to the upper end of the forward upright member 20, at an orientation that can be easily viewable to a user of the fitness device 10. Referring to FIG. 3, detail of an example view screen is seen. The view screen 27 conveys information both to and from the user. The view screen 27 includes at least one display 29 and various keyboard interfaces 31. In accordance with the principles of the present invention, a system is provided to provide biometric identification of a user of fitness equipment. Biometrics as used herein refers to the analysis of physiological or behavioral characteristics to identify or verify a user of the fitness equipment. Examples include fingerprint, hand geometry, face, voice, eye, etc. In accordance with one embodiment of the present invention, the biometric sensor 33 can be provided on the electronic housing 28.

Referring to FIG. 4, a schematic of example electronics of the present invention is seen. The view screen 27 can include a microprocessor 34 that is connected to the display 29 and to the various keyboard interfaces 31. The microprocessor 34 is also connected to the biometric sensor 33, as described in detail below. The microprocessor is further connected to memory 36. In one embodiment, the view screen 27 can include a display console circuit board such as a T2 board; the microprocessor can be a microcontroller such as for example an Atmel AT mega 128 processor with 16 MHz clock available from Atmel Corporation, 2325 Orchard Parkway, San Jose, Calif. 95131 USA; the memory can be flash memory such as a flash Erasable Programmable Read-Only Memory (EPROM); Random Access memory (RAM); and Electrically Erasable Programmable Read-Only Memory (EEPROM).

The T2 board can include a connector for loading and reading flash and EEPROM memory. The connector can be for example a JTAG connector available from JTAG Technologies Inc., 1006 Butterworth Court, Stevensville, Md. 21666 USA Multiple serial ports can be provided for: communications with the local processor; Communication Specification for Fitness Equipment (CSAFE) communications; and USB, wireless or other form of network interface.

Electronic devices may be incorporated into the fitness device 10 such as timers, odometers, speedometers, heart rate indicators, energy expenditure recorders, controls, etc. A speed sensor can be preferably provided. In one embodiment, the speed sensor can be based on zero crossing of one phase of a SPAM generator, 51 pulses per revolution or 2 strides. A resistance can be provided by brake. A heart rate interface can supports a Polar heart rate receiver available from Polar Electro Inc., 1111 Marcus Avenue, Suite M15, Lake Success, N.Y. 11042 USA.

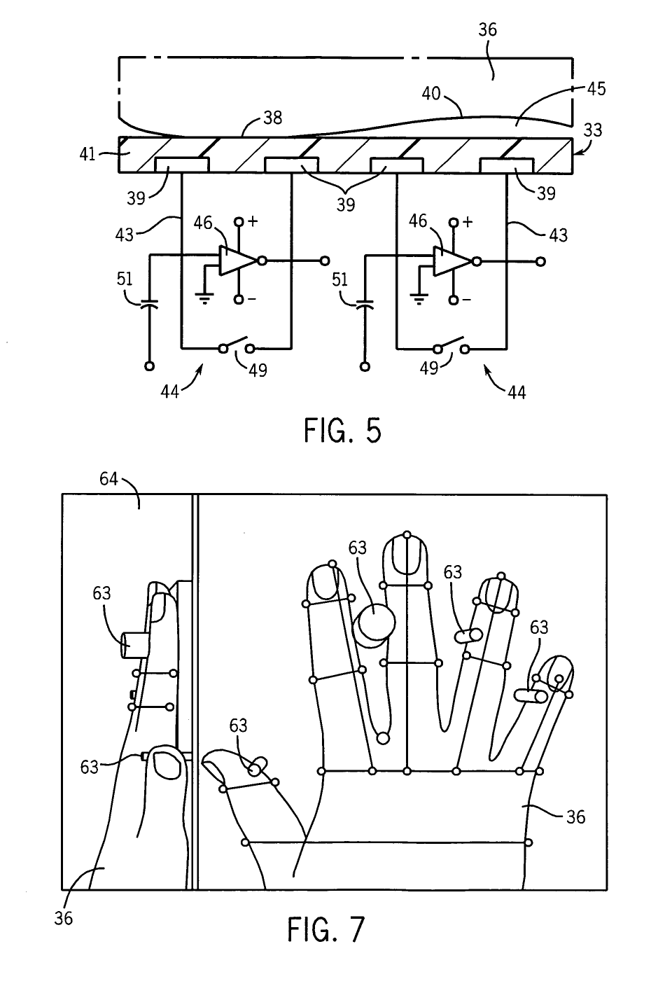

A biometric user identification system in accordance with the principles of the present invention comprises a capture mechanism, a processing mechanism, and a storage mechanism. In one embodiment of a biometric sensor in accordance with the present invention, the processing mechanism comprises the microprocessor 34 and the storage mechanism comprises the memory 36. In one embodiment of a biometric sensor in accordance with the present invention, the capture mechanism comprises the biometric sensor 33. In one embodiment of a biometric sensor in accordance with the present invention, the biometric sensor comprises a fingerprint biometric system. In a further embodiment of the present invention, a capacitive fingerprint scanner can be utilized. The capacitive fingerprint scanner generates an image of the ridges and valleys that make up a fingerprint by use of an electrical current. Referring to FIG. 5, an electric circuit diagram showing an example capacitive fingerprint scanner is seen. A close-up of a finger 36 is seen. The finger 36 close-up shows a fingerprint ridge 38 and valley 40. The sensor 33 is comprised of one or more semiconductor chips containing an array of cells. Each cell includes two conductor plates 39, covered with an insulating layer 41, which comprises a capacitor. The cells can be smaller than the width of a ridge on a finger.

The sensor is connected to an integrator 44. The integrator comprises an inverting operational amplifier 46 as well as a number of transistors, resistors, and capacitors. The non-inverting terminal of operational amplifier 46 is connected to ground, and the inverting terminal is connected to a reference voltage supply and a feedback loop 43. The feedback loop 43, which is also connected to the operational amplifier 46 output, includes the two conductor plates 39.

The surface of the finger 36 acts as a third capacitor plate, separated by the insulating layers 41 in the cell structure and, in the case of the fingerprint valleys 40, a pocket of air 45. Varying the distance between the capacitor plates (by moving the finger 36 closer or farther away from the conductor plates 39) changes the total capacitance of the capacitor. Thus, the capacitor in a cell under a fingerprint ridge 38 will have a greater capacitance than the capacitor in a cell under a fingerprint valley 40.

To scan the finger, the microprocessor 34 first closes a reset switch 49 for each cell, which shorts the input and output of the operational amplifier 46 to “balance” the integrator 44. When the reset switch 49 is opened again, and the microprocessor applies a fixed charge to the integrator 44 and the various capacitors charge up. The capacitance of a capacitor 51 in the feed back loop affects the voltage at the input of the inverting operational amplifier 46, which affects the output of the inverting operational amplifier 46. Since the distance to the finger 36 alters capacitance, a finger ridge 38 will result in a different voltage output than a finger valley 40.

The microprocessor 34 reads this voltage output and determines whether it is characteristic of a fingerprint ridge 38 or valley 40. By reading the cells in the sensor array, the microprocessor can put together an overall image of the fingerprint. The fingerprint of the user can then be compared to an image of users' fingerprint previously registered in the memory 36 of the device.

In an alternative embodiment, a biometric fingerprint identification device in accordance with the principles of the present invention can utilize an optical scanner. The optical scanner is a charge coupled device comprising an array of light-sensitive diodes called photosites. The charge coupled device generates an electrical signal in response to light photons. Each photosite records a pixel representing the light that hit a particular spot. Collectively, the light and dark pixels form an image of the scanned finger. Typically, an analog-to-digital converter processes the analog electrical signal to generate a digital representation of the fingerprint image.

In one embodiment, a biometric identification system with the brand name FingerChip™ biometrics sensor available from Atmel Corporation, 2325 Orchard Parkway, San Jose, Calif. 95131 USA can be utilized. The FingerChip™ biometrics sensor is a fingerprint sensor that uses thermal sensing technology that measures the temperature difference according to whether the finger skin touches the sensing area (for a fingerprint ridge) or not (for a fingerprint valley). The FingerChip™ biometrics sensor is made of a silicon die covered by a pyro-electric material, a material that is sensitive to temperature differences. The die itself is made of a matrix of adjacent pixels.

The temperature difference initially appearing at the pyro-electric layer contact is transformed into electrical charges due to the properties of the material. The electrical charges are then amplified and measured by the underlying silicon pixels, in order to create an accurate transcription of the fingerprint of a user.

Use of thermal technology operates well under drastic environmental conditions that can be found in the exercise environment, such as extreme temperatures, high humidity, and water (sweat) contamination. This thermal technology has a small dependence of distance between the finger and the sensor, allows complete encapsulation and protection of the sensor with a very robust coating, providing a very high resistance to shocks, abrasion, water or any other environmental stress.

The FingerChip™ biometrics sensor uses a sweeping procedure to acquire successive slices of the fingerprint, before reconstructing the complete fingerprint. This process reduces the required size of the silicon to manufacture a fingerprint sensor, which costs less and reduces latent prints naturally present on the surface of area sensors. Finally, the FingerChip™ biometrics sensor is self-cleaning since no latent print is left on the imaging surface.

Yet another example of such biometric fingerprint identification system is the EntréPad™ biometrics sensor available from AuthenTec, Inc., 709 South Harbor City Boulevard, Melbourne, Fla. 32901 USA. The EntréPad™ is a fingerprint sensor that uses radio frequency (RF) signals to detect the fingerprint ridges and valleys. The fingerprint sensor includes a sensing area. The RF electronic imaging works by reading the fingerprint pattern from the live, highly-conductive layer of skin that lies just beneath the dry outer surface layer of the skin, when the user's finger is placed on or near to the sensing area of the sensor.

While these example biometric fingerprint sensors utilize capacitive sensing, optical imaging, thermal sensing and radio frequency sensing, the present invention is directed at all biometric sensors such as for example infrared gauging, and mechanical force measurement.

In some applications or in some locations, the use of a fingerprint biometric identification system may not be desired. Thus, in an alternative embodiment the capture mechanism comprises an alternative biometric such as for example hand geometry. A biometric identification system based upon the geometry of the human hand is generally not as detailed as fingerprint identification systems, and, in some applications or uses, may be desired over a fingerprint identification system.

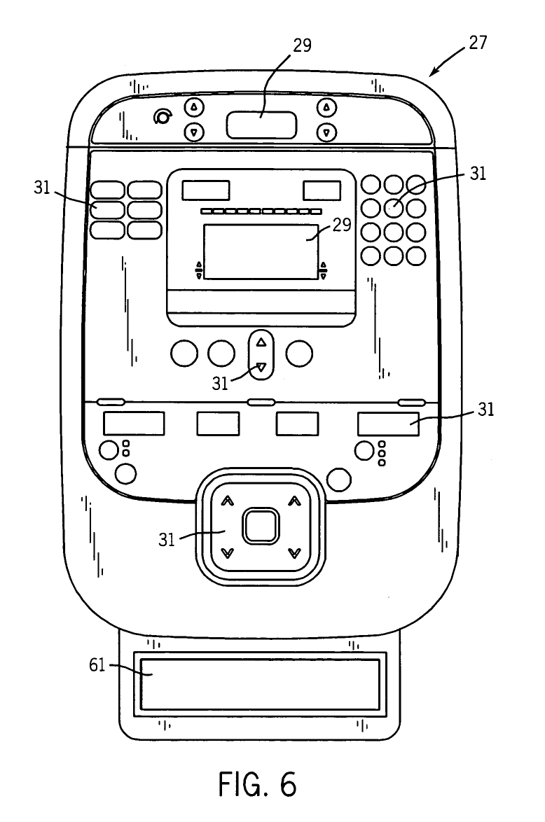

Referring to FIG. 6, a view screen and electronic housing incorporating a hand geometry biometric identification system in accordance with the principles of the present invention is seen. A slot 61 can be provided in electronic housing into which the user places his or her hand. A hand geometry biometric identification system of the present invention measures finger length, thickness, and curvature for the purposes of verification of the user. The image acquisition system can comprise a light source, a camera, a mirror, and a flat surface. The user places his or her hand—palm facing downwards—on a flat surface of the device.

Referring to FIG. 7, a schematic showing the hand measurements of a hand geometry biometric identification system of the present invention is seen. A placement mechanism such as four pegs 63 serves as control points for an appropriate placement of the hand 36 of the user. A mirror can project the side-view of the hand of the user onto the camera. The camera is connected to the microprocessor in the display 29. In one embodiment, the view screen 27 can include a graphical user interface (GUI) application which provides a live visual feedback of the top-view and the side-view of the hand. Feature extraction involves computing the widths and lengths of the fingers at various locations using the captured image. These metrics define the feature vector of the hand of the user. The hand of the user is compared to an image of users' hands previously registered in the memory of the device.

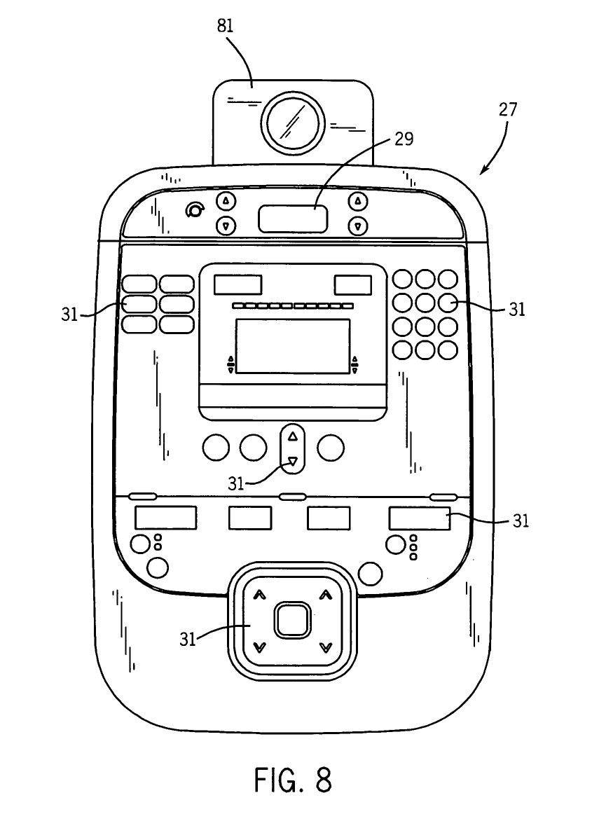

One drawback of the use of fingerprint and hand biometric identification systems is that both require physical contact with the user. Thus, in an alternative embodiment the capture mechanism comprises an alternative biometric such as for example a biometric face identification or recognition system. Referring to FIG. 8, a view screen and electronic housing incorporating a face identification biometric system in accordance with the principles of the present invention is seen. A digital camera 81 is provided that captures a digital image of the user. The digital image of the user is compared to a digital image of users' faces previously registered in the memory of the device.

In a further alternative embodiment, the capture mechanism comprises a contact less palm vein authentication system. Palm vein patterns are unique with each individual and vein patterns do not change over the lifetime of a person. The palm vein recognition biometric can comprise a low-intensity infra-red light emitter and an optical sensor. Upon exposure to the low-intensity infra-red light, the veins just beneath the skin of the palm then emit a black reflection, giving a picture of the veins in the palm. A pattern is then extracted from this picture. Furthermore, palm vein pattern authentication includes minimal impact from such factors as injuries, skin chafing, and strong resistance to impact from changes in external environmental factors. The hand is suspended in the air over, or adjacent to, the reader for reading and authentication, thus it is unnecessary to touch surfaces that others have come into physical contact with.

As previously noted, in addition to a capture mechanism a biometric user identification system in accordance with the principles of the present invention comprises a processing mechanism and a storage mechanism. In an initial step, in order to verify the identity of a fitness device user, a sample of the chosen biometric is captured. Data is then extracted by the fitness device microcontroller and stored as a template in the fitness device flash memory or at a remote location.

A biometric user identification system in accordance with the principles of the present invention further comprises an authentication process. During the authentication process, the user of the fitness equipment presents their biometric to the capture mechanism. Utilizing a matching algorithm contained within the fitness equipment microprocessor or a remote microprocessor, the processing system compares the live biometric with the stored templates. If a match is made, the person is identified and granted access.

In an alterative embodiment, the fitness equipment can be in communication with a central processor such as a server at a health club or at a remote location that contains the matching algorithm biometric templates for identification. The central processor can include for example user information such as statistics on the user, the past workouts of the user, future planned workout regimes for the user, entertainment preferences, etc. Once the biometric has identified the user, the user information stored on the central processor can be provided to the fitness equipment and displayed on the view screen at the control of the user.

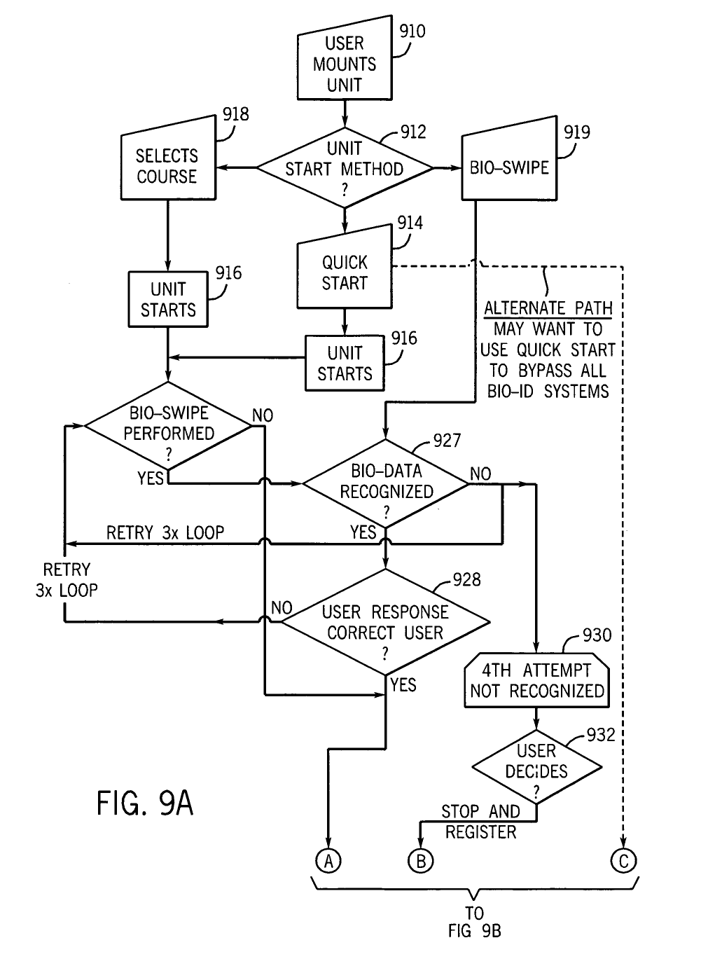

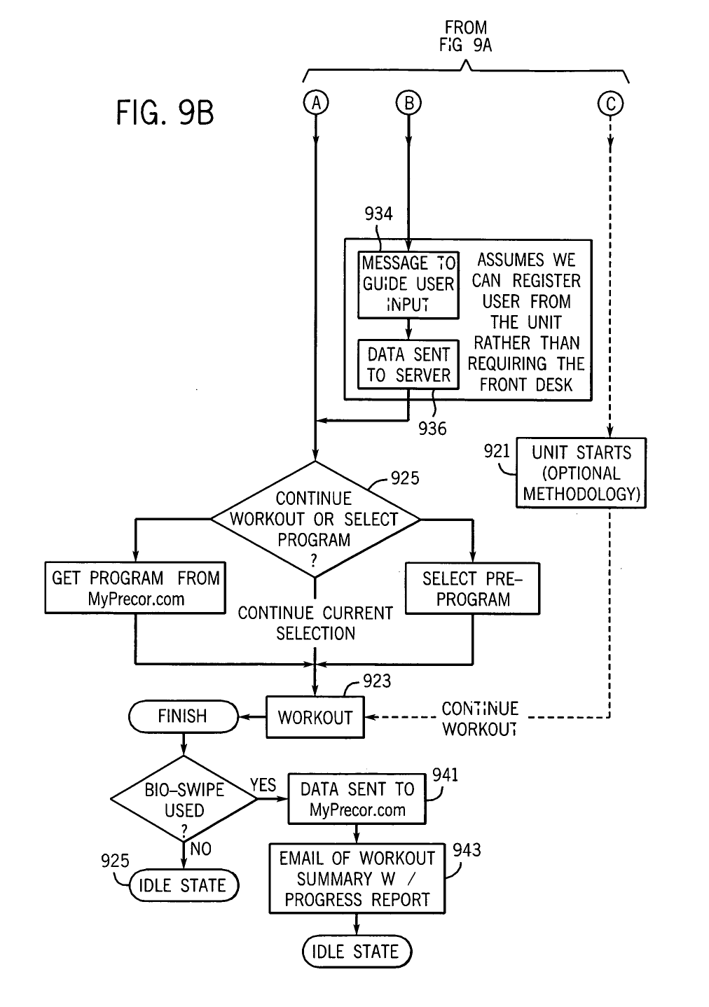

The biometric user identification systems of the present invention are configurable for use in a wide variety of different fitness equipment operating or control systems. Referring to FIG. 9, a flow chart of an example biometric user identification system of the present invention is seen. After the user mounts the exercise device 910, the exercise device is started 912. The user can select either a quick start 914, which simply starts the exercise device 916, can select a specific course 918 which starts the exercise device 916 on the selected course or can initiate the session by utilizing the biometric user identification system of the present invention 919. If the user selects the quick start 914, the user can either simply manually set the exercise device to the desired workout and bypass the biometric user identification system 921, or can use the biometric user identification system to identify themselves to the system. If the user bypasses the biometric user identification system 921 and manually sets the exercise device to the desired workout, the workout 923 ensues and upon conclusion of the workout, the system goes into an idle state 925.

If the user selects a specific course 918, again, the user can bypass the biometric user identification system 921 or can use the biometric user identification system to identify themself to the system. If the user bypasses the biometric user identification system and simply continue the selected course program 923. In such case, the system accesses the selected course program 925, the workout 923 ensues, and upon conclusion of the workout, the system goes into an idle state 925.

If the user has used the biometric user identification system to identify themself to the system, the system utilizes the matching algorithm to compare the live biometric with the stored templates 927. If a match is made, the system queries the user as to whether the identified user is indeed the user. The user can then verify themselves as the correct user 928, the person is identified and granted access, and the system accesses the selected course program 925, the workout 923 ensues.

If the user has used the biometric user identification system to identify them self to the system, and a match is not made, the system instructs the user to repeat the biometric user identification process. In the event of continued lack of a match, the system allows a preselected number of retries such as for example four 930, upon which the user is given the option of registering with the system by providing a sample of the chosen biometric to be captured 932. In one embodiment, such user registration can be required to be done at a central location such as for example the front desk of an exercise facility. In another embodiment, user registration can be done at the exercise device itself. In this embodiment, the system prompts the user through the registration steps 934 and the biometric data is then extracted and stored as a template 936.

If the user has used the biometric user identification system to identify them self to the system, upon conclusion of the workout, the system can collect and store data from the workout with user information. If such capability is provided, the data can be sent for example to a remote location 941, a summary can be provided to the user 943 of the workout and perhaps prior workouts and guidelines for future workouts.

While the invention has been described with specific embodiments, other alternatives, modifications and variations will be apparent to those skilled in the art. As previously described, while the example embodiment depicts a total body elliptical fitness cross-training device, the principles of the present invention apply to any other fitness devices, including but not limited to treadmills, stair climbers, stationary bikes, rowing machines, stair climbers, weight resistance machines and the like. In addition, while the preferred biometrics described herein is fingerprinting, hand geometry and/or face recognition biometrics, additional biometrics such as, for example, voice, eye, etc. can be utilized. Accordingly, it will be intended to include all such alternatives, modifications and variations set forth within the spirit and scope of the appended claims.

What is claimed is:

1. An operating system architecture for a fitness trainer comprising:
a display;
a processor in communication with the display;
a hardware circuit board in communication with the processor;
memory in communication with the hardware circuit board and the processor; and
a biometric capture mechanism in communication with the processor and the memory, the memory being capable of storing template biometric data with which biometric data captured by the biometric capture mechanism is compared.

2. The operating system architecture for a fitness trainer of claim 1 wherein the biometric capture mechanism is a fingerprint biometric system.

3. The operating system architecture for a fitness trainer of claim 1 wherein the biometric capture mechanism is a hand geometry biometric system.

4. The operating system architecture for a fitness trainer of claim 1 wherein the biometric capture mechanism is a face identification biometric system.

5. The operating system architecture for a fitness trainer of claim 2, wherein the fingerprint biometric system is a capacitive fingerprint identification system.

6. The operating system architecture for a fitness trainer of claim 5, wherein the capacitive fingerprint identification system includes a sensor comprised of at least one semiconductor chip.

7. The operating system architecture for a fitness trainer of claim 6, wherein the semiconductor chip comprises an array of cells, and wherein each cell includes at least two conductor plates and an insulating layer.

8. The operating system architecture for a fitness trainer of claim 6, wherein the sensor is coupled to an integrator.

9. The operating system architecture for a fitness trainer of claim 2, wherein the fingerprint biometric system comprises an optical scanner.

10. The operating system architecture for a fitness trainer of claim 9, wherein the optical scanner includes an array of light-sensitive diodes.

11. The operating system architecture for a fitness trainer of claim 10, wherein each light-sensitive diode records a pixel representing the amount of light hitting a particular location of the light-sensitive diode.

12. The operating system architecture for a fitness trainer of claim 2, wherein the fingerprint biometric system includes a thermal sensor having a sensing area, and wherein the thermal sensor is capable of measuring the temperature difference a first location upon which a ridge of a user's fingerprint contacts the thermal sensor and a second location wherein the user's fingerprint does not contact the thermal sensor.

13. The operating system architecture for a fitness trainer of claim 12, wherein the thermal sensor comprises a die including a plurality of pixels, and wherein the die is covered by a pyro-electric material.

14. The operating system architecture for a fitness trainer of claim 2, wherein the fingerprint biometric system includes a radio frequency sensor and a sensing area, and wherein the radio frequency sensor is capable of detecting the ridges and valleys of a user's fingerprint when the user's finger is applied having a sensing area.

15. The operating system architecture for a fitness trainer of claim 3, wherein the hand geometry biometric system comprises a hand placement mechanism and an image acquisition system, and wherein the hand placement mechanism facilitates the alignment of a user's hand relative for image capture by the image acquisition system.

16. The operating system architecture for a fitness trainer of claim 1 wherein the memory in communication with the hardware circuit board and the processor is at a remote location.

17. The operating system architecture for a fitness trainer of claim 16 wherein the remote memory includes user information that can be provided on the display.

18. The operating system architecture for a fitness trainer of claim 1, wherein the biometric capture mechanism is a palm vein authentication system.

19. The operating system architecture for a fitness trainer of claim 18, wherein the palm vein authentication system includes an infra-red light emitting device and an optical sensor.

20. A fitness device comprising:
a frame having a pivot axis defined thereon, the frame configured to be supported on a floor;
first and second foot links, each foot link including a first portion and a second portion;
first and second foot supporting portions for receiving the feet of the user, the first and second foot support portions supported by the first and second foot links, respectively;
a coupling associated with the first portion of each foot link for coupling the first portion of each foot link to the pivot axis so that the first portion of each foot link travels in a closed path relative to the pivot axis;
a guide associated with the frame and operative to engage and direct the second portions of the foot links along preselected reciprocating paths of travel as the first portions of the respective foot links travel along their paths of travel, so that when the exercise device is in use the foot support portion moves along a generally elliptical path of travel;
a display in communication with the foot link;
a processor in communication with the display;
memory in communication with the processor; and
a biometric capture mechanism in communication with the processor and the memory.

21. The fitness device of claim 20 wherein the biometric capture mechanism is a fingerprint biometric system.

22. The fitness device of claim 20 wherein the biometric capture mechanism is a hand geometry biometric system.

23. The fitness device of claim 20 wherein the biometric capture mechanism is a face identification biometric system.

24. The fitness device of claim 21, wherein the fingerprint biometric system is a capacitive fingerprint identification system.

25. The fitness device of claim 21, wherein the fingerprint biometric system comprises an optical scanner.

26. The fitness device of claim 21, wherein the fingerprint biometric system includes a thermal sensor having a sensing area, and wherein the thermal sensor is capable of measuring the temperature difference a first location upon which a ridge of a user's fingerprint contacts the thermal sensor and a second location wherein the user's fingerprint does not contact the thermal sensor.

27. The fitness device of claim 21, wherein the fingerprint biometric system includes a radio frequency sensor and a sensing area, and wherein the radio frequency sensor is capable of detecting the ridges and valleys of a user's fingerprint when the user's finger is applied having a sensing area.

28. The fitness device of claim 20, wherein the biometric capture mechanism is a palm vein authentication system.

29. The fitness device of claim 28, wherein the palm vein authentication system includes an infra-red light emitting device and an optical sensor.

30. A system of identifying a user for a fitness trainer comprising:
capturing a user biometric;
extracting data from the biometric and storing the data as a template;
capturing a sample of the chosen biometric;
the user of the fitness equipment presenting a live biometric; and
utilizing a matching algorithm, comparing the live biometric with the stored templates;
whereby, if a match is made, the user is granted access to operate the fitness trainer.

31. The system of identifying a user for a fitness trainer of claim 30 wherein the step of capturing a user biometric comprises capturing a user fingerprint.

32. The system of identifying a user for a fitness trainer of claim 31 wherein the step of capturing a user fingerprint biometric comprises measuring a fingerprint with a finger capacitance sensing system.

33. The system of identifying a user for a fitness trainer of claim 31 wherein the step of capturing a user fingerprint biometric comprises measuring a fingerprint with a finger biometric thermal sensing system.

34. The system of identifying a user for a fitness trainer of claim 31 wherein the step of capturing a user fingerprint biometric comprises measuring a fingerprint with a radio frequency (RF) sensing system.

35. The system of identifying a user for a fitness trainer of claim 30 wherein the step of capturing a user biometric comprises capturing a user hand biometric.

36. The system of identifying a user for a fitness trainer of claim 30 wherein the step of capturing a user biometric comprises capturing a user face biometric.

37. The system of identifying a user for a fitness trainer of claim 30, wherein the biometric capture mechanism is a palm vein authentication system.
